(19) United States
(12) Patent Application Publication
(10) Pub. No.: US 2025/0367059 A1
(43) Pub. Date: Dec. 4, 2025

(54) MASSAGE DEVICE

(71) Applicant: AISIN CORPORATION, Kariya, Aichi (JP)

(72) Inventors: Tomoko KANBARA, Kariya-shi, Aichi-ken (JP); Yasuhito KUREMATSU, Kariya-shi, Aichi-ken (JP); Satoshi MASUDA, Kariya-shi, Aichi-ken (JP); Kentaro OZAWA, Kariya-shi, Aichi-ken (JP)

(73) Assignee: AISIN CORPORATION, Kariya, Aichi (JP)

(21) Appl. No.: 18/848,301

(22) PCT Filed: Apr. 24, 2023
(86) PCT No.: PCT/JP2023/016101

§ 371 Date: Sep. 18, 2024

(30) Foreign Application Priority Data
Jun. 30, 2022 (JP) 2022-105914

(51) Int. Cl. A61H 9/00

(52) U.S. Cl. CPC A61H 9/0078; A61H 2201/0103; A61H 2201/0149; A61H 2201/1246; A61H 2201/1623; A61H 2203/0431; A61H 2205/081; A61H 2205/086

(57) ABSTRACT

A massage device includes an air bag (41) that is configured to inflate with intake of air and that is configured to deflate with discharge of the air, a support member that supports the air bag (41), and an intermediate sheet (43) that is disposed between the air bag (41) and the support member and that is stiffer than the support member.

### CROSS REFERENCE TO RELATED APPLICATIONS

This application is a National Stage of International Application No. PCT/JP2023/016101 filed on Apr. 24, 2023, claiming priority based on Japanese Patent Application No. 2022-105914 filed on Jun. 30, 2022, the entire contents of which are incorporated in their entirety.

### TECHNICAL FIELD

The present disclosure relates to a massage device.

### BACKGROUND ART

Patent Literature 1 describes a vehicle seat device that is a massage device. The massage device includes a seat cushion that supports the buttocks and legs of a user, a seatback that supports the back of the user, and a plurality of air bags incorporated in the seat cushion and the seatback. The air bags inflate by being supplied with air and deflate by discharging the air. The massage device massages the user by causing the plurality of air bags to inflate or deflate.

### CITATION LIST

### Patent Literature

Patent Literature 1: JP 2021-45280 A

### SUMMARY OF THE DISCLOSURE

### Technical Problems

In the massage device as described above, when the air bag inflates, the air bag in some cases sinks into the seat cushion and the seatback. As a result, a force of the air bag pressing the user may decrease.

### Solution to Problems

A massage device according to an aspect of the present disclosure includes an air bag that is configured to inflate with intake of air and that is configured to deflate with discharge of the air, a support member that supports the air bag, and an intermediate sheet that is disposed between the air bag and the support member and that is stiffer than the support member.

### BRIEF DESCRIPTION OF DRAWINGS

FIG. 1 is a perspective view of a massage device according to a first embodiment.

FIG. 2 is a plan view of a massage unit of the massage device of FIG. 1.

FIG. 3 is an end view of the massage unit of FIG. 2 along line 3-3 of FIG. 2.

FIG. 4 is an end view of the massage unit of FIG. 3 when an air bag thereof inflates.

FIG. 5 is a plan view of a massage unit of a massage device according to a second embodiment.

FIG. 6 is an end view of the massage unit of FIG. 5 along line 6-6 of FIG. 5.

FIG. 7 is an end view of the massage unit of FIG. 6 when an air bag thereof inflates.

### DESCRIPTION OF EMBODIMENTS

### First Embodiment

Hereinafter, a massage device 10 according to a first embodiment will be described. In the drawings, for simplification of illustration, hatching indicating a cross section of a metal material is used for a cross section of a member that is not a metal material.

### <Configuration of First Embodiment>

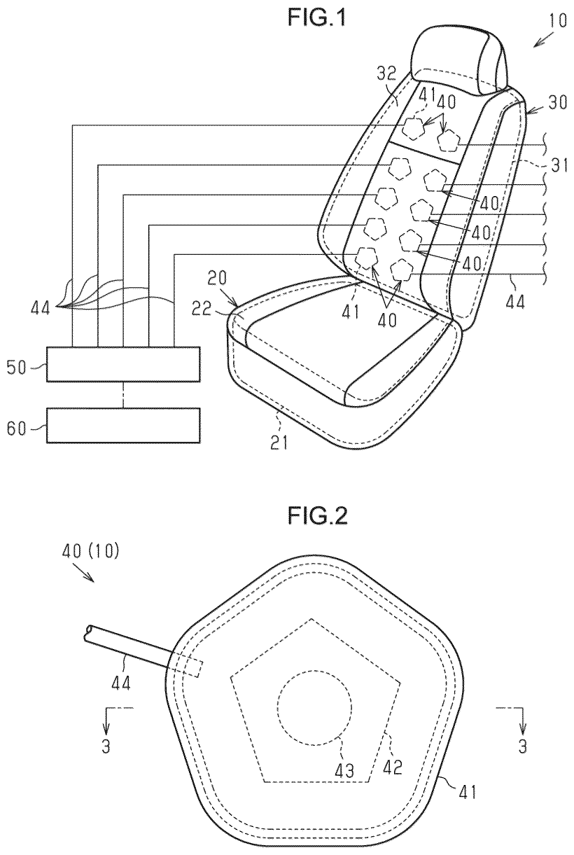

As shown in FIG. 1, the massage device 10 includes a seat cushion 20, a seatback 30, a plurality of massage units 40, a drive part 50, and a remote controller 60. The massage device 10 of the present embodiment is a vehicle seat having a massage function. In another embodiment, the massage device 10 may be a massage chair installed at home or the like.

The seat cushion 20 is a portion on which a user sits. The seat cushion 20 includes a cushion member 21 having appropriate elasticity, and a cover 22 covering the cushion member 21. The seatback 30 is a portion that supports the back of the user. The seatback 30 includes a cushion member 31 having appropriate elasticity, and a cover 32 covering the cushion member 31. An example of the material of the cushion members 21, 31 is polyurethane. In the present embodiment, the cushion member 31 corresponds to a “support member” supporting an air bag 41 to be described later.

### <Massage Unit 40>

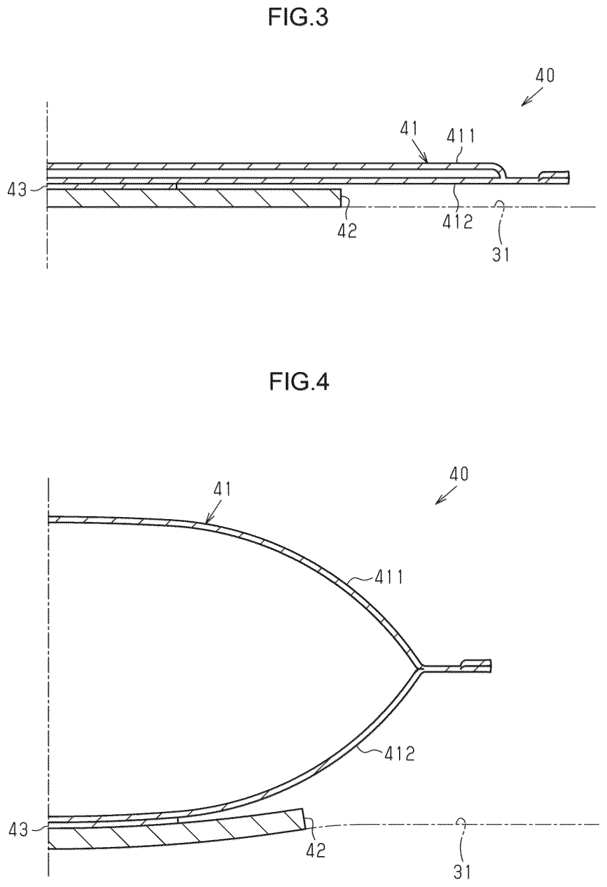

As shown in FIGS. 2 and 3, the massage unit 40 includes the air bag 41, an intermediate sheet 42, a joining portion 43, and a connection tube 44. In the massage unit 40, the air bag 41 and the intermediate sheet 42 are provided on the cushion member 31 in a state of overlapping with each other. In the following description, a direction in which the air bag 41, the intermediate sheet 42, and the cushion member 31 overlap with one another is referred to as a stacking direction.

As shown in FIG. 1, the plurality of air bags 41 are arranged to be arrayed in a height direction and a width direction with respect to the seatback 30. Specifically, the air bags 41 are arranged to be an array of five air bags 41 in the height direction by two air bags 41 in the width direction. In addition, the plurality of air bags 41 are supported by the cushion member 31 of the seatback 30, and are covered with the cover 32 of the seatback 30.

As shown in FIGS. 2 and 3, the air bag 41 is formed by welding two films 411, 412. The material of the films 411, 412 is preferably a resin material having appropriate elasticity. In plan view in the stacking direction, each of the films 411, 412 has a pentagonal shape. In plan view in the stacking direction, the shape of the films 411, 412 may be another polygonal shape or a circular shape. The air bag 41 inflates with intake of air and deflates with discharge of the air.

The intermediate sheet 42 has a sheet shape by being formed of cloth such as woven fabric or nonwoven fabric. The fibers forming the intermediate sheet 42 may be plant fibers, animal fibers, or chemical fibers. The thickness of the intermediate sheet 42 is thicker than the thicknesses of the films 411, 412 forming the air bag 41. The thickness of the intermediate sheet 42 is sufficient if the thickness is, for example, about several millimeters. The intermediate sheet 42 is stacked to the air bag 41 via the joining portion 43. In plan view in the stacking direction, the intermediate sheet 42 is smaller than the air bag 41. In other words, the intermediate sheet 42 is hidden behind the air bag 41. In plan view in the stacking direction, the intermediate sheet 42 has a pentagonal shape like the shapes of the films 411, 412. The shape of the intermediate sheet 42 may be different from the shapes of the films 411, 412, and may have, for example, a circular shape.

The intermediate sheet 42 is made of a material stiffer than the cushion member 31 of the seatback 30. In other words, the elastic modulus of the intermediate sheet 42 is higher than the elastic modulus of the cushion member 31 of the seatback 30. That is, the displacement amount of the intermediate sheet 42 exhibited when a certain load is applied is smaller than the displacement amount of the cushion member 31 of the seatback 30 exhibited when the same load is applied.

The intermediate sheet 42 is fixed to the cushion member 31. The intermediate sheet 42 may be fixed to the cushion member 31 with a pin inserted into both the intermediate sheet 42 and the cushion member 31. In addition, the intermediate sheet 42 may be fixed to the cushion member 31 by bonding, sewing, or the like.

The joining portion 43 joins the film 412 of the air bag 41 and the intermediate sheet 42 to each other. In the present embodiment, the joining portion 43 is a portion where the intermediate sheet 42 is welded to the film 412. In this respect, the material of the intermediate sheet 42 is preferably a material that is easily welded to the film 412. In another embodiment, the joining portion 43 may be a portion where the intermediate sheet 42 is bonded to the film 412.

In plan view in the stacking direction, the joining portion 43 joins a central portion of the film 412 and a central portion of the intermediate sheet 42 to each other. In other words, the joining portion 43 does not exist between a portion excluding the central portion of the intermediate sheet 42 and a portion excluding the central portion of the film 412. Here, in plan view in the stacking direction, the joining portion 43 is simply required to join a portion including the center of the film 412 and a portion including the center of the intermediate sheet 42 to each other. As an example, an area of the film 412 joined through the joining portion 43 is sufficient if this area is about several percent to 20 percent of the total area of the film 412. In addition, the joining strength of the joining portion 43 is simply required to be a strength with which the air bag 41 and the intermediate sheet 42 are not separated from each other even if the inflation and deflation of the air bag 41 are repeated.

As shown in FIGS. 1 and 2, a first end of the connection tube 44 is connected to the air bag 41. On the other hand, a second end of the connection tube 44 is connected to the drive part 50. The connection tube 44 is made of an elastomer such as rubber or resin. The connection tube 44 preferably has appropriate elasticity. The connection tube 44 is a flow path through which air passes when the air bag 41 inflates or deflates.

As shown in FIG. 1, the drive part 50 supplies air to the plurality of air bags 41, or causes the air to be discharged from the plurality of air bags 41. The drive part 50 includes, for example, a pump that sends out air, a valve unit that switches a connection destination of a specified air bag 41 among the plurality of air bags 41 to the pump or the atmosphere, and a control unit that controls the pump and the valve unit. The drive part 50 is connected to a power supply source such as a battery of the vehicle, for example. The remote controller 60 transmits, upon being operated by the user, a signal in response to the operation to the drive part 50. For example, the remote controller 60 preferably has a power button of the massage device 10 and a button for selecting massage intensity.

<Operation of First Embodiment>In a case where the massage device 10 massages the user, the drive part 50 supplies air to the plurality of air bags 41 or causes the air to be discharged from the plurality of air bags 41 at a predetermined cycle.

As shown in FIG. 4, the air bag 41 inflates when air is taken into the air bag 41. Here, the intermediate sheet 42 stiffer than the cushion member 31 exists between the air bag 41 and the cushion member 31. Thus, even when the air bag 41 inflates, the air bag 41 hardly sinks into the cushion member 31. In other words, the air bag 41 is easily displaced toward the body of the user.

### <Effects of First Embodiment>

(1-1) In the massage device 10, the intermediate sheet 42 stiffer than the cushion member 31 exists between the air bag 41 and the cushion member 31. Thus, when the air bag 41 inflates, the air bag 41 hardly sinks into the cushion member 31. In this manner, it is possible to prevent a decrease in the force of the air bag 41 pressing the user.

(1-2) In a case where the intermediate sheet 42 is larger than the air bag 41 in plan view in the stacking direction, the intermediate sheet 42 stiffer than the cushion member 31 protrudes with respect to the air bag 41. Thus, even if the air bag 41, together with the intermediate sheet 42, is covered with the cover 32, there is a possibility that the user feels uncomfortable when the body of the user indirectly touches the protruding portion of the intermediate sheet 42 at the time of using the massage device 10. In this respect, in the massage device 10 described above, the intermediate sheet 42 is smaller than the air bag 41 in plan view in the stacking direction, and thus the occurrence of the above situation can be avoided.

(1-3) In the massage device 10, the intermediate sheet 42 is joined to the air bag 41, and thus the intermediate sheet 42 can be handled integrally with the air bag 41 at the time of manufacturing the massage device 10. Specifically, by fixing an integral body of the air bag 41, the intermediate sheet 42, and the joining portion 43 to the cushion member 31, the air bag 41, together with the intermediate sheet 42, can be supported by the cushion member 31. Thus, it is not necessary to separately fix the air bag 41 and the intermediate sheet 42 to the cushion member 31.

(1-4) For example, in the case of a comparative example in which all the portions of the air bag 41 and the intermediate sheet 42 facing each other in the stacking direction are joined through the joining portion 43, the intermediate sheet 42 may hinder the inflation of the air bag 41. In this respect, in the massage device 10 described above, the joining portion 43 simply joins the central portion of the intermediate sheet 42 to the central portion of the air bag 41. Thus, it is possible to avoid a situation in which the air bag 41 is not inflated normally by the intermediate sheet 42.

### Second Embodiment

Hereinafter, a massage device 10A according to a second embodiment will be described. In the description of the second embodiment, points different from the first embodiment will be mainly described. In other words, description of points common to the first embodiment will be omitted.

### <Massage Unit 40A>

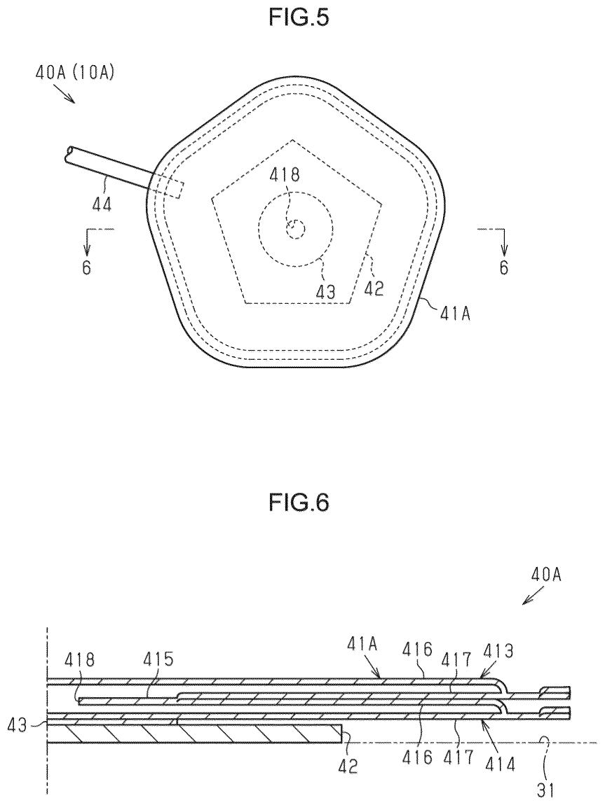

As shown in FIGS. 5 and 6, a massage unit 40A includes an air bag 41A, the intermediate sheet 42, the joining portion 43, and the connection tube 44.

The air bag 41A includes a first bag body 413 and a second bag body 414 that inflate with intake of air and deflate with discharge of air, and a bag body joining portion 415 joining the first bag body 413 and the second bag body 414 to each other. The first bag body 413 is formed by welding two films 416, 417. Similarly, the second bag body 414 is formed by welding two films 416, 417. The bag body joining portion 415 is formed by joining the film 417 forming the first bag body 413 and the film 416 forming the second bag body 414 to each other. Specifically, the bag body joining portion 415 is a portion where the film 416 forming the second bag body 414 is welded to the film 417 forming the first bag body 413. The bag body joining portion 415 has a thin disk shape. The bag body joining portion 415 includes a communication hole 418 allowing the inside of the first bag body 413 and the inside of the second bag body 414 to communicate with each other. Thus, the first bag body 413 and the second bag body 414 inflate or deflate in a similar manner. Note that the sizes of the first bag body 413 and the second bag body 414 may be different from each other.

In plan view in the stacking direction, the intermediate sheet 42 is smaller than the air bag 41A. In addition, in plan view in the stacking direction, the intermediate sheet 42 is larger than the bag body joining portion 415.

The joining portion 43 joins the film 417 of the second bag body 414 of the air bag 41A and the intermediate sheet 42 to each other. In the present embodiment, the joining portion 43 is a portion where the intermediate sheet 42 is welded to the film 417 of the second bag body 414. In plan view in the stacking direction, the joining portion 43 joins a central portion of the film 417 and a central portion of the intermediate sheet 42 to each other. When viewed in the stacking direction, the joining portion 43 has a size equivalent to the size of the bag body joining portion 415.

### <Operation of Second Embodiment>

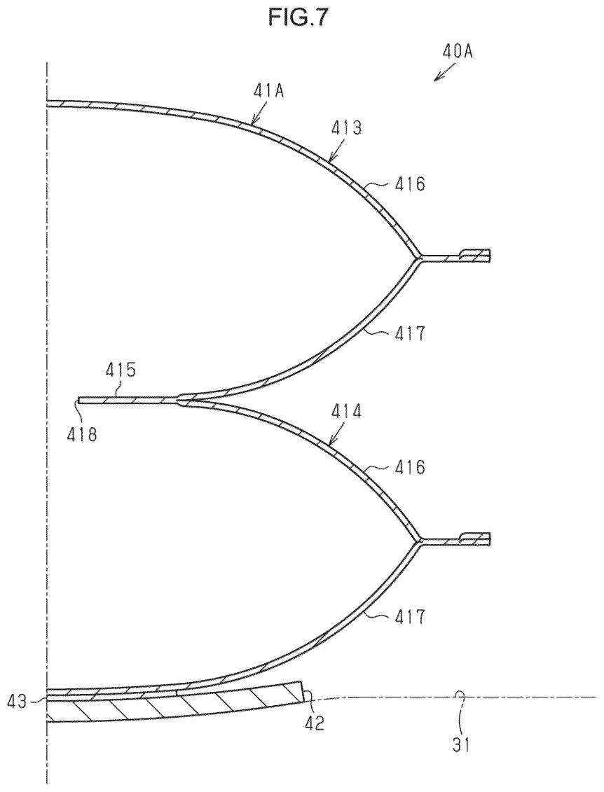

As shown in FIG. 7, the first bag body 413 and the second bag body 414 of the air bag 41A inflate when air is taken into the air bag 41A. Here, the intermediate sheet 42 stiffer than the cushion member 31 exists between the air bag 41A and the cushion member 31. Thus, even when the air bag 41A inflates, the air bag 41A hardly sinks into the cushion member 31. In other words, the air bag 41A is easily displaced toward the body of the user.

### <Effects of Second Embodiment>

The second embodiment can obtain effects equivalent to the effects of the first embodiment. Further, the second embodiment can obtain the following effects.

(2-1) In a case where the intermediate sheet 42 is smaller than the bag body joining portion 415, the second bag body 414 easily sinks into the cushion member 31 when the second bag body 414 inflates. In this respect, the intermediate sheet 42 is larger than the bag body joining portion 415, and thus it is possible to prevent the second bag body 414 from sinking into the cushion member 31 when the second bag body 414 inflates.

(2-2) The air bag 41A includes the first bag body 413 and the second bag body 414 arranged in the stacking direction. Thus, the massage device 10A can increase an inflation amount of the air bag 41A in the stacking direction while an increase in the size of the air bag 41A can be reduced. That is, the massage device 10A can enhance a massage effect for the user.

### MODIFICATION EXAMPLES

Each of the above embodiments can be modified and implemented as follows.

The above embodiments and the following modification examples can be implemented in combination with each other within a range in which technical inconsistency does not occur.
The intermediate sheet 42 may have a film shape or a sheet shape. That is, the intermediate sheet 42 need not be an aggregate of fibers.
The material of the intermediate sheet 42 may be the same as the material of the films 411, 412 forming the air bag 41. The shape of the intermediate sheet 42 may be the same as the shape of the films 411, 412 forming the air bag 41. In this respect, the intermediate sheet 42 may be the films 411, 412 forming the air bag 41. According to this configuration, it is not necessary to prepare the intermediate sheet 42 as a separate member.
The cushion member 31 may include a receiving recess portion that receives the intermediate sheet 42 therein. With this modification example, it is possible to reduce a change in thickness due to the intermediate sheet 42 being provided between the air bag 41 and the cushion member 31. In addition, it is easy to position the intermediate sheet 42 with respect to the cushion member 31.
The cushion member 31 to which the air bag 41 is provided may be the cushion member 21 of the seat cushion 20. In addition, the air bag 41 may be provided to a cushion member that supports another portion of the user.
In the massage unit 40, the air bag 41 and the intermediate sheet 42 need not be joined to each other through the joining portion 43. In this case, the air bag 41 and the intermediate sheet 42 are preferably fixed to the cushion member 31 separately.
In plan view in the stacking direction, the intermediate sheet 42 may have a size equivalent to the size of the air bag 41, or the intermediate sheet 42 may be larger than the air bag 41.
The thickness of the central portion of the intermediate sheet 42 may be different from the thickness of the portion excluding the central portion of the intermediate sheet 42. For example, the thickness of the central portion of the intermediate sheet 42 may be made thicker than the thickness of another portion. With this modification example, it is possible to reduce an amount of sinking of the air bag 41 into the cushion member 31 when the air bag 41 inflates.
A plurality of intermediate sheets 42 may be provided. For example, a plurality of relatively thin intermediate sheets 42 may be disposed between the air bag 41 and the cushion member 31. In this modification example, it is possible to adjust an amount of sinking of the inflating air bag 41 into the cushion member 31 by adjusting the number of the intermediate sheets 42.
The massage device 10 may be a sheet-shaped massage device that can be folded or rolled, and that is configured to be detachable from a chair. In this case, the “support member” supporting the air bag 41 and the intermediate sheet 42 preferably has a thin sheet shape.

### SUMMARY OF PRESENT EMBODIMENT

The present embodiment includes at least the following configurations.

A massage device (10; 10A) includes: an air bag (41; 41A) configured to inflate with intake of air and configured to deflate with discharge of the air; a support member supporting the air bag (41; 41A); and an intermediate sheet (42) disposed between the air bag (41; 41A) and the support member, the intermediate sheet (42) being stiffer than the support member.

In the massage device, the intermediate sheet stiffer than the support member exists between the air bag and the support member. Thus, when the air bag inflates, the air bag hardly sinks into the support member. In this manner, the massage device can prevent a decrease in the force of the air bag pressing a user.

Further, in the present embodiment, preferably, a direction in which the air bag (41; 41A), the intermediate sheet (42), and the support member overlap with one another is a stacking direction, and the intermediate sheet (42) is smaller than the air bag (41; 41A), in plan view in the stacking direction.

In a case where the intermediate sheet is larger than the air bag in plan view in the stacking direction, the intermediate sheet stiffer than the support member protrudes with respect to the air bag. Thus, even if the air bag, together with the intermediate sheet, is covered with a cover, there is a possibility that the user feels uncomfortable when the body of the user touches a certain portion of the intermediate sheet at the time of using the massage device. In this respect, in the massage device described above, the intermediate sheet is smaller than the air bag in plan view in the stacking direction, and thus the occurrence of the above situation can be avoided.

Further, in the present embodiment, a joining portion (43) joining the air bag (41; 41A) and the intermediate sheet (42) to each other is preferably provided.

In the massage device, the intermediate sheet is joined to the air bag, and thus the intermediate sheet can be handled integrally with the air bag.

Further, in the present embodiment, preferably, a direction in which the air bag (41; 41A), the intermediate sheet (42), and the support member overlap with one another is a stacking direction, and the joining portion (43) joins a central portion of the air bag (41; 41A) and a central portion of the intermediate sheet (42) to each other, in plan view in the stacking direction.

For example, in the case of a comparative example in which all the portions of the air bag and the intermediate sheet facing each other in the stacking direction are joined through the joining portion, the intermediate sheet may hinder the inflation of the air bag. In this respect, in the massage device described above, the joining portion simply joins the central portion of the air bag and the central portion of the intermediate sheet. Thus, it is possible to avoid a situation in which the air bag is not inflated normally by the intermediate sheet.

Further, in the present embodiment, preferably, a direction in which the air bag (41; 41A), the intermediate sheet (42), and the support member overlap with one another is a stacking direction, the air bag (41; 41A) includes a first bag body (413) and a second bag body (414) that are configured to inflate with intake of air and configured to deflate with discharge of the air, and a bag body joining portion (415) joining the first bag body (413) and the second bag body (414) to each other in the stacking direction, the bag body joining portion (415) includes a communication hole (418) allowing an inside of the first bag body (413) and an inside of the second bag body (414) to communicate with each other, and the intermediate sheet (42) is positioned between the second bag body (414) and the support member in the stacking direction, and is larger than the bag body joining portion (415) in plan view in the stacking direction.

In a case where the intermediate sheet is smaller than the bag body joining portion, the second bag body easily sinks into the support member when the second bag body inflates. In this respect, the intermediate sheet is larger than the bag body joining portion, and thus it is possible to prevent the second bag body from sinking into the support member when the second bag body inflates.

### REFERENCE SIGNS LIST

10, 10A: Massage device, 20: Seat cushion, 21: Cushion member, 22: Cover, 30: Seatback, 31: Cushion member (support member), 32: Cover, 40, 40A: Massage unit, 41, 41A: Air bag, 411, 416: Film, 412, 417: Film, 413: First bag body, 414: Second bag body, 415: Bag body joining portion, 418: Communication hole, 42: Intermediate sheet, 43: Joining portion, 44: Connection tube, 50: Drive part, and 60: Remote controller

1. A massage device comprising:
an air bag configured to inflate with intake of air and configured to deflate with discharge of air;
a support member supporting the air bag; and
an intermediate sheet disposed between the air bag and the support member, the intermediate sheet being stiffer than the support member.

2. The massage device according to claim 1, wherein
a direction in which the air bag, the intermediate sheet, and the support member overlap with one another is a stacking direction, and
the intermediate sheet is smaller than the air bag, in plan view in the stacking direction.

3. The massage device according to claim 1, further comprising:
a joining portion joining the air bag and the intermediate sheet to each other.

4. The massage device according to claim 3, wherein
a direction in which the air bag, the intermediate sheet, and the support member overlap with one another is a stacking direction, and
the joining portion joins a central portion of the air bag and a central portion of the intermediate sheet to each other, in plan view in the stacking direction.

5. The massage device according to claim 1, wherein
a direction in which the air bag, the intermediate sheet, and the support member overlap with one another is a stacking direction,
the air bag includes a first bag body and a second bag body that are configured to inflate with intake of air and configured to deflate with discharge of air, and a bag body joining portion joining the first bag body and the second bag body to each other in the stacking direction,
the bag body joining portion includes a communication hole allowing an inside of the first bag body and an inside of the second bag body to communicate with each other, and
the intermediate sheet is positioned between the second bag body and the support member in the stacking direction, and is larger than the bag body joining portion in plan view in the stacking direction.
